(19) United States
(12) Patent Application Publication
(10) Pub. No.: US 2018/0189586 A1
(43) Pub. Date: Jul. 5, 2018

(54) Storage with In-situ String-Searching Capabilities

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/784,074

(22) Filed: Oct. 13, 2017

Related U.S. Application Data
(63) Continuation-in-part of application No. 15/452,728, filed on Mar. 7, 2017.

(30) Foreign Application Priority Data
Mar. 7, 2016 (CN) 201610127981.5
Mar. 3, 2017 (CN) 201710122861.0
Mar. 7, 2017 (CN) 201710130887.X
Jun. 18, 2017 (CN) 201710461236.9
Jun. 19, 2017 (CN) 201710461243.9

(51) Int. Cl. G06K 9/00; G06F 17/30; G06F 21/56; G06K 9/62; G11C 13/00; G11C 15/00; G11C 17/10; G11C 17/16; G11C 5/02; G11C 5/06

(52) U.S. Cl. CPC G06K 9/00973; G06F 17/30985; G06F 21/564; G06K 9/62; G11C 13/0002; G11C 2213/71; G11C 17/10; G11C 17/165; G11C 5/025; G11C 5/063; G06F 2221/032; G11C 15/00

(57) ABSTRACT

The present invention discloses a three-dimensional memory (3D-M) with in-situ string-searching capabilities (3D-M_{SS}). It comprises a plurality of storage-processing units (SPU). Each SPU comprises at least a 3D-M array for storing computer data and a pattern-processing circuit for searching the computer data for a search string. The 3D-M array is stacked above the pattern-processing circuit. Multiple 3D-M_{SS} dice can form a storage card or a solid-state drive with in-situ string-searching capabilities.

### CROSS-REFERENCE TO RELATED APPLICATIONS

This application is a continuation-in-part of application “Distributed Pattern Processor Comprising Three-Dimensional Memory”, application Ser. No. 15/452,728, filed Mar. 7, 2017, which claims priorities from Chinese Patent Application No. 201610127981.5, filed Mar. 7, 2016; Chinese Patent Application No. 201710122861.0, filed Mar. 3, 2017; Chinese Patent Application No. 201710130887.X, filed Mar. 7, 2017, in the State Intellectual Property Office of the People's Republic of China (CN).

This application also claims priorities from Chinese Patent Application No. 201710461236.9, filed Jun. 18, 2017; Chinese Patent Application No. 201710461243.9, filed Jun. 19, 2017, in the State Intellectual Property Office of the People's Republic of China (CN), the disclosures of which are incorporated herein by references in their entireties.

### BACKGROUND

### 1. Technical Field of the Invention

The present invention relates to the field of integrated circuit, and more particularly to a storage with in-situ string-searching capabilities.

### 2. Prior Art

Big data is a term for data sets that are so large or complex that conventional data processing methods are inadequate to deal with them. Big data philosophy encompasses unstructured, semi-structured and structured data, however the main focus is on unstructured data. With high volume, high velocity and high variety, big-data analytics demand cost-effective and innovative forms of information processing.

An important aspect of big-data analytics is string searching. The basic string-searching operations are pattern matching and/or pattern recognition. Pattern matching and pattern recognition are the acts of searching a target pattern (i.e. the pattern to be searched) for the presence of the constituents or variants of a search pattern (i.e. the pattern used for searching). The match usually has to be “exact” for pattern matching, while it could be “likely to a certain degree” for pattern recognition. In the case of big-data analytics, the target pattern is a computer data, while the search pattern is a search string. Unless explicitly stated, the present invention does not differentiate pattern matching and pattern recognition. They are collectively referred to as pattern processing. In addition, search patterns and target patterns are collectively referred to as patterns.

Big data has become big: its “size” ranges from a few dozen of TBs to many PBs and is still growing. This makes it difficult to use a conventional computer to perform big-data analytics. Based on the von Neumann architecture, the storage and the processor of the conventional computer are separated. Because a conventional storage is “dumb”, i.e. without any analyzing capabilities per se, the data to be analyzed have to be read out from the storage first, which could take hours. Consequently, the von Neumann architecture is inefficient for big-data analytics. At present, big-data analytics generally requires tens, hundreds, or even thousands of servers.

### OBJECTS AND ADVANTAGES

It is a principle object of the present invention to improve the efficiency of big-data analytics.

It is a further object of the present invention to improve the string-searching speed for big data.

It is a further object of the present invention to provide a storage with in-situ string-searching capabilities at a reasonable cost.

In accordance with these and other objects of the present invention, the present invention discloses a storage with in-situ string-searching capabilities.

### SUMMARY OF THE INVENTION

The present invention discloses a storage with in-situ string-searching capabilities. It is primarily a storage, with string searching as its secondary function. Compared with prior art, the preferred storage is “smarter”, i.e. it has an in-situ pattern-processing capabilities. To be more specific, the primary purpose of the preferred storage is to store data, while its secondary purpose is to search the stored data for at least a search string from an input.

The preferred storage comprises at least a three-dimensional memory (3D-M) die. The 3D-M die is a monolithic integrated circuit comprising a plurality of storage-processing units (SPU). Each SPU comprises a pattern-processing circuit and at least a 3D-M array. The 3D-M array stores computer data, while the pattern-processing circuit searches the computer data for the search string. The 3D-M array is stacked above the pattern-processing circuit and is communicatively coupled with the pattern-processing circuit through a plurality of contact vias. These contact vias are collectively referred to as inter-storage-processor (ISP) connection. Vertically stacked, this type of integration is referred to as 3-D integration. With in-situ string-searching capabilities, the preferred 3D-M of the present invention is referred to as 3D-M_{SS}.

The 3-D integration of the memory circuit (i.e. 3D-M array) and the processing circuit (i.e. pattern-processing circuit) offers many advantages. Although there is a growing trend to integrate a processing circuit into a memory circuit, the type of integration used by prior art is a two-dimensional (2-D) integration. To be more specific, the processing circuit and the memory circuit are formed side-by-side on the surface of a semiconductor substrate. With the 2-D integration, adding pattern-processing circuits into a memory die would increase the die size, which results in a higher die cost.

In contrast, with the 3-D integration, adding pattern-processing circuits into a 3D-M die will not increase the die size because the pattern-processing circuits are formed under the 3D-M array. It should be noted that most of the substrate area can be used to form the pattern-processing circuits, since the peripheral circuits of the 3D-M array only occupy a small portion of the substrate area. Better yet, because the peripheral circuits of the 3D-M array need to be formed anyway and the pattern-processing circuits can be considered as a byproduct of the peripheral circuits as they are formed at the same time, integrating the pattern-processing circuits into the 3D-M die does not increase its overall manufacturing cost. For a given storage capacity, a “smart” 3D-M_{SS}, which has string-searching capabilities, costs almost as much as a conventional “dumb” 3D-M, which is just a simple storage.

Besides the cost advantage, the 3-D integration provides a better performance. With the 2-D integration, the connections between the memory circuits and the processing circuits are long (at least tens of microns) and few (tens to hundreds). In comparison, with the 3-D integration, the contact vias between the 3D-M arrays and the pattern-processing circuits are short (microns) and numerous (thousands). As a result, the ISP-connection in the preferred 3D-M_{SS} has a large bandwidth.

Accordingly, the present invention discloses a storage with in-situ string-searching capabilities, comprising: an input for transferring at least a search string; a semiconductor substrate having transistors thereon; a plurality of storage-processing units (SPU) on said semiconductor substrate, each of said SPUs comprising at least a three-dimensional memory (3D-M) array for storing at least a computer data and a pattern-processing circuit for searching said computer data for said search string; wherein said pattern-processing circuit is formed on said semiconductor substrate; said 3D-M array is stacked above said pattern-processing circuit and communicatively coupled with said pattern-processing circuit by a plurality of contact vias.

As used herein, the phrase “permanent” is used in its broadest sense to mean any long-term storage; the phrase “communicatively coupled” is used in its broadest sense to mean any coupling whereby information may be passed from one element to another element; the symbol “/” refers to an “and” or “or” relationship, e.g. “text/code” means “text” only, “code” only, or “text” and “code” both; the phrase “data” is used both in both singular and plural forms

### BRIEF DESCRIPTION OF THE DRAWINGS

FIG. 1 is a circuit block diagram of a preferred 3D-M_{SS};

FIGS. 2A-2C are circuit block diagrams of three preferred storage-processing units (SPU);

FIG. 3 is a cross-sectional view of a preferred SPU comprising at least a three-dimensional writable memory (3D-W) array;

FIG. 4 is a perspective view of a preferred SPU;

FIGS. 5A-5C are substrate layout views of three preferred SPUs.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

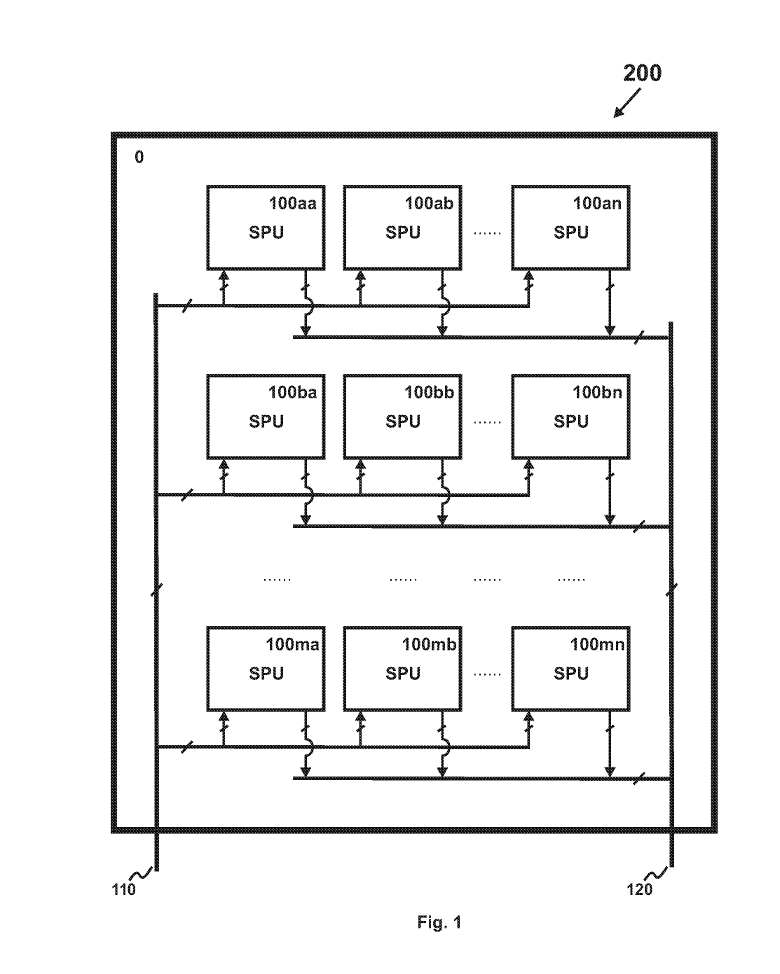

Referring now to FIG. 1, a preferred storage with in-situ string-searching capabilities is disclosed. It comprises at least a three-dimensional memory (3D-M) with in-situ string-searching capabilities (3D-M_{SS}) 200. The preferred 3D-M_{SS} 200 not only stores computer data, but also performs string search in situ. It comprises m*n storage-processing units (SPU) 100aa-100mn. Each SPU is commutatively coupled with an input 110 and an output 120. The input 110 transfers at least a search string, while the output 120 transfers at least a result of string searching.

As used herein, a computer (or, a computer system) includes any device(s) with a processor and a memory. Such devices can range from non-networked standalone devices as simple as calculators, to networked computing devices such as “smart” devices, including smart-phones, televisions and tiny devices as part of the Internet of Things (IoT). The computer data could be a part of a document, a file, a message, a program, or the like. The search string could include a key word, a search word, a regular expression, or the like.

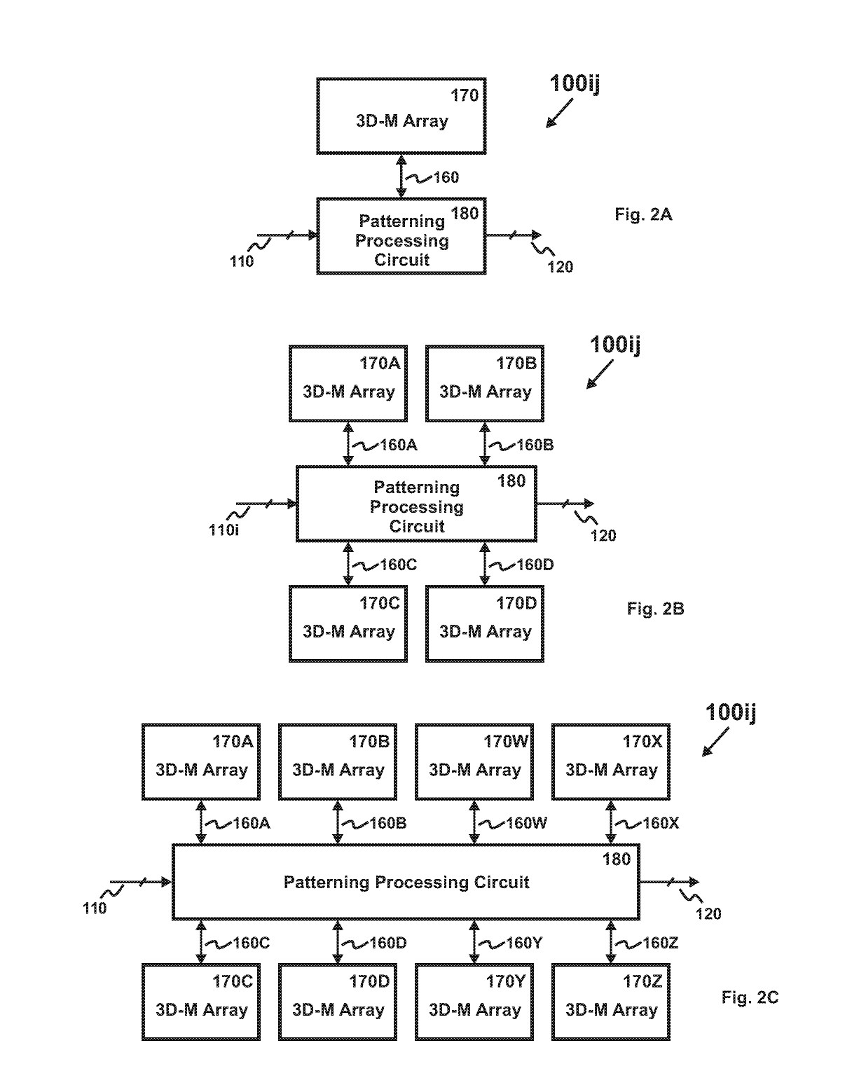

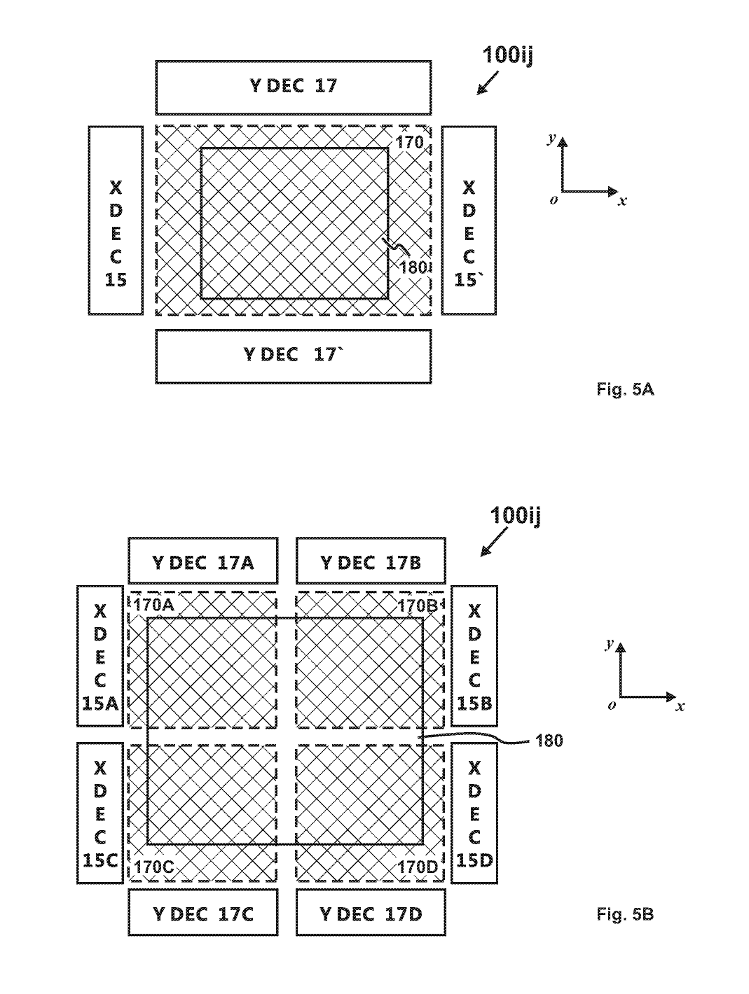

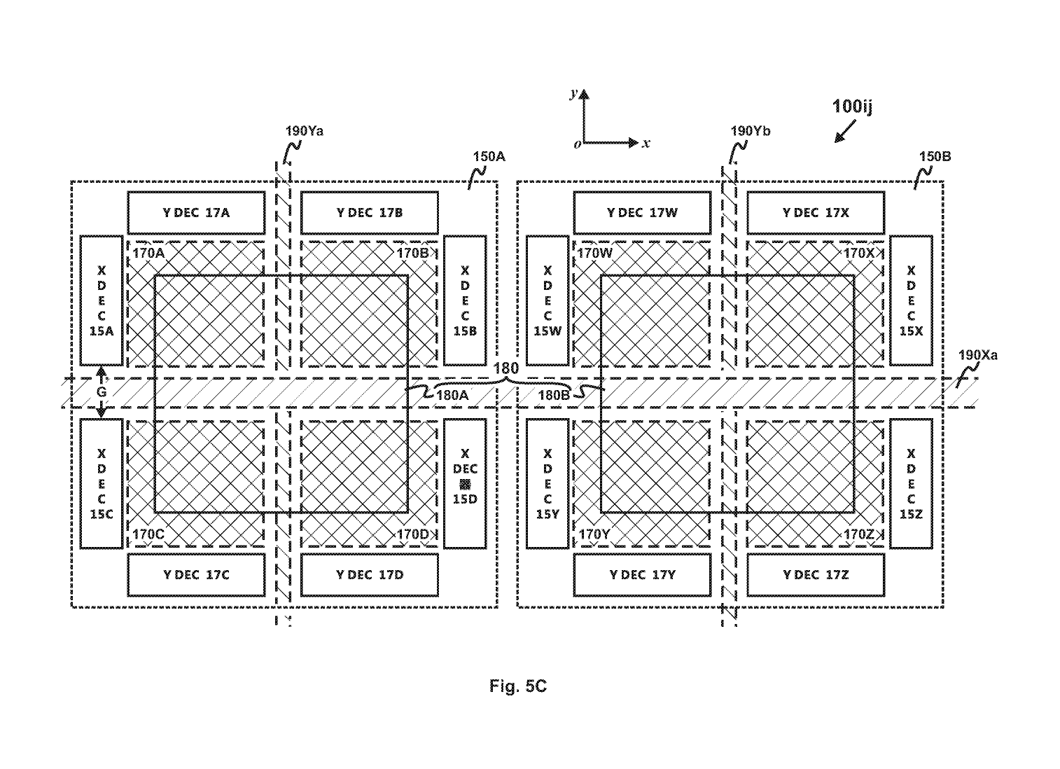

FIGS. 2A-2C discloses three preferred SPUs 100ij. Each SPU 100ji comprises a pattern-processing circuit 180 and at least a 3D-M array 170 (or, 170A-170D, 170W-170Z), which are communicatively coupled through an inter-storage-processor (ISP) connection 160 (or, 160A-160D, 160W-160Z). The 3D-M array 170 stores at least a computer data, which is compared with the search string during the string-search operation. In these embodiments, the pattern-processing circuit 180 works with different number of 3D-M arrays. In the first embodiment of FIG. 2A, the pattern-processing circuit 180 works with one 3D-M array 170. In the second embodiment of FIG. 2B, the pattern-processing circuit 180 works with four 3D-M arrays 170A-170D. In the third embodiment of FIG. 2C, the pattern-processing circuit 180 works with eight 3D-M array 170A-170D, 170W-170Z. As will become apparent in FIGS. 5A-5C, the more 3D-M arrays it comprises, a larger footprint and more functions will the SPU 100ij have.

The pattern-processing circuit 180 performs pattern matching and/or pattern recognition. It may take many forms. In one example, since a portion of the search string can be represented by a string of characters, the pattern-processing circuit 180 may comprise a text-matching circuit or a code-matching circuit. The text/code-matching circuits could be implemented by a content-addressable memory (CAM) or a comparator including XOR circuits. In another example, since another portion of the search string can be represented by a regular expression, the pattern-processing circuit 180 can be implemented by finite-state automata (FSA) circuits, which include non-deterministic FSA (NFA) circuits or deterministic FSA (DFA) circuits. It should be noted that, besides string searching, the pattern-processing circuit 180 may perform other functions, e.g. filtering, sorting, malware-screening, etc.

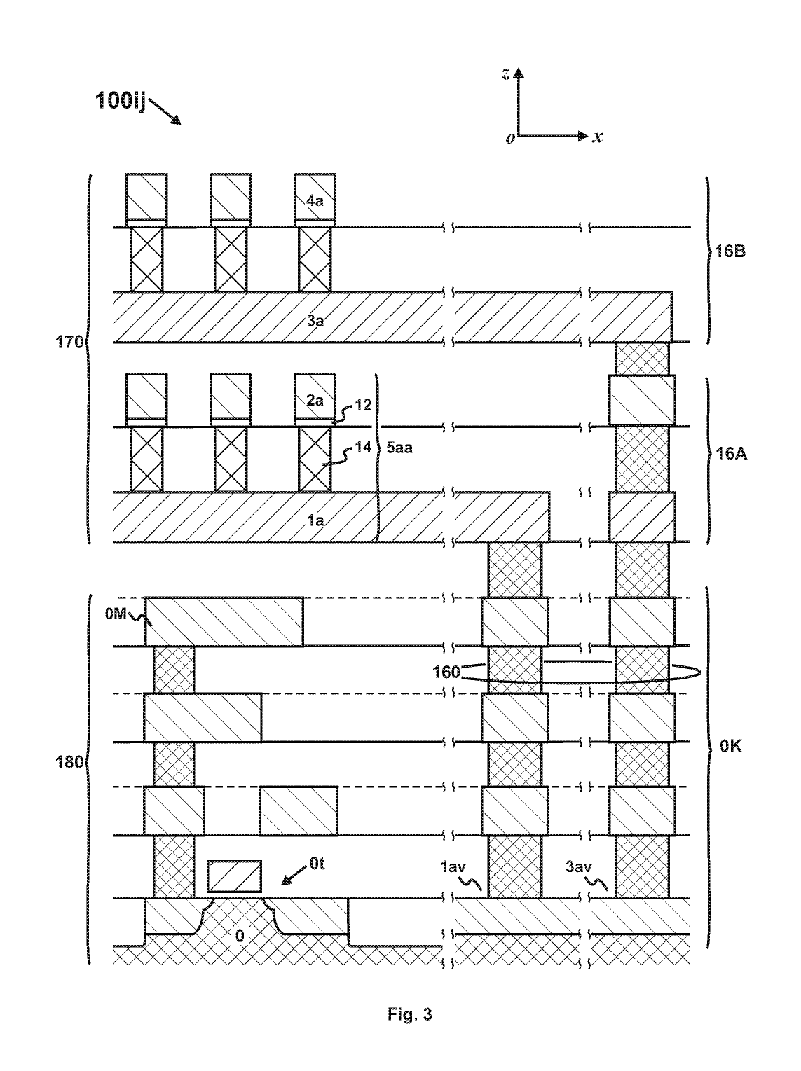

Referring now to FIG. 3, a preferred SPU 100ij comprising at least a 3D-M array is shown. The 3D-M is a monolithic semiconductor memory comprising a plurality of memory cells stacked above and coupled to a semiconductor substrate. A 3D-M array is a collection of the 3D-M cells sharing at least one address line. The most common 3D-M is three-dimensional read-only memory (3D-ROM), which permanently stores information.

Based on the orientation of the memory cells, the 3D-M can be categorized into three-dimensional horizontal memory (3D-M_{H}) and three-dimensional vertical memory (3D-M_{V}). In a 3D-M_{H}, all address lines are horizontal and the memory cells form a plurality of horizontal memory level(s). A well-known 3D-M_{H} is 3D-XPoint. In a 3D-M_{V}, at least one set of the address lines are vertical and the memory cells form a plurality of vertical memory strings. A well-known 3D-M_{V} is 3D-NAND. In general, the 3D-M_{H} (e.g. 3D-XPoint) is faster, while the 3D-M_{V} (e.g. 3D-NAND) is denser.

The 3D-M suitable for computer storage is three-dimensional writable memory (3D-W), whose cells are electrically programmable. Based on the number of programming allowed, a 3D-W can be further categorized into three-dimensional one-time-programmable memory (3D-OTP) and three-dimensional multiple-time-programmable memory (3D-MTP). Types of the 3D-MTP cell include flash-memory cell, memristor, resistive random-access memory (RRAM or ReRAM) cell, phase-change memory (PCM) cell, programmable metallization cell (PMC), conductive-bridging random-access memory (CBRAM) cell, and the like.

The 3D-W comprises a substrate circuit OK formed on the substrate 0. A first memory level 16A is stacked above the substrate circuit OK, with a second memory level 16B stacked above the first memory level 16A. The substrate circuit OK includes the peripheral circuits of the memory levels 16A, 16B, as well as the pattern-processing circuits 180. It comprises transistors 0t and the associated interconnect 0M. Each of the memory levels (e.g. 16A, 16B) comprises a plurality of first address-lines (i.e. y-lines, e.g. 2a, 4a), a plurality of second address-lines (i.e. x-lines, e.g. 1a, 3a) and a plurality of 3D-W cells (e.g. 5aa). The first and second memory levels 16A, 16B are coupled to the substrate circuit OK through contact vias 1av, 3av, respectively. Coupling the 3D-M array 170 and the pattern-processing circuit 180, the contacts vias 1av, 3av are collectively referred to as inter-storage-processor (ISP) connection 160.

In this preferred embodiment, the 3D-W cell 5aa comprises a programmable layer 12 and a diode layer 14. The programmable layer 12 could be an OTP layer (e.g. an antifuse layer, used for the 3D-OTP) or an MTP layer (e.g. a phase-change layer, used for the 3D-MTP). The diode layer 14 is broadly interpreted as any layer whose resistance at the read voltage is substantially lower than the case when the applied voltage has a magnitude smaller than or polarity opposite to that of the read voltage. The diode could be a semiconductor diode (e.g. p-i-n silicon diode), or a metal-oxide (e.g. TiO₂) diode.

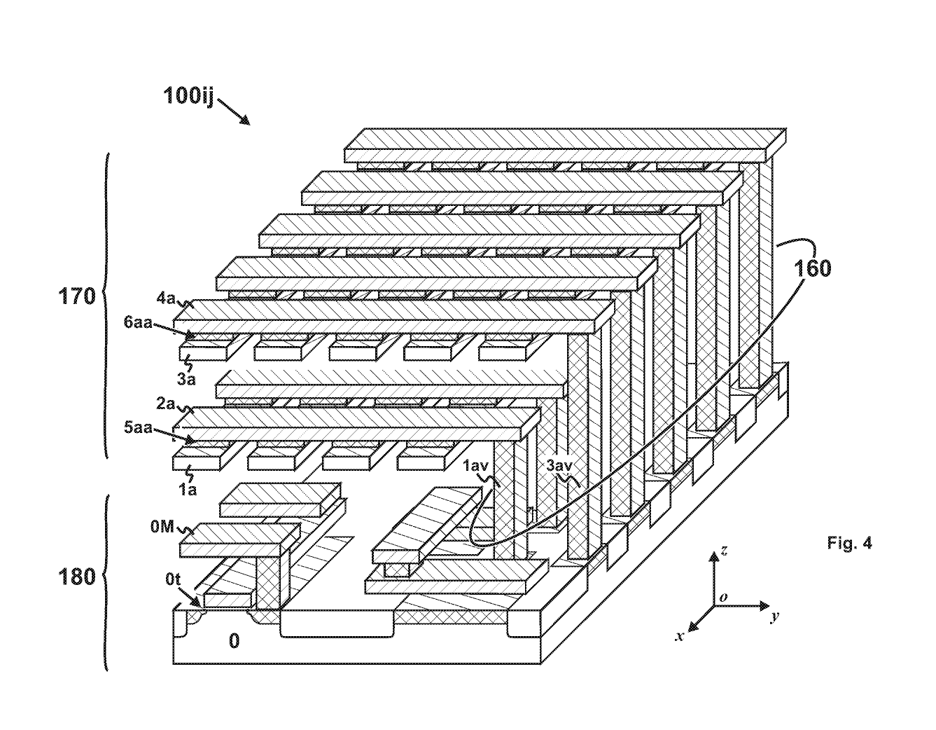

Referring now to FIG. 4, a perspective view of the SPU 100ij is shown. The 3D-M array 170 storing the computer data is stacked above the pattern-processing circuit 180. The pattern-processing circuit 180 is formed on the substrate 0 and is at least partially covered by the 3D-M array 170. With the 3-D integration, the footprint of the SPU 100ij is the larger one of the 3D-M array 170 and the pattern-processing circuit 180. This is significantly smaller than the case of the 2-D integration, where the footprint of an integrated die is the sum of those of the memory circuits and the processing circuits.

Besides a smaller die size, the 3-D integration provides a better performance. With the 2-D integration, the connections between the memory circuits and the processing circuits are long (at least tens of microns) and few (tens to hundreds). In comparison, with the 3-D integration, the contact vias 1av, 3av between the 3D-M arrays 170 and the pattern-processing circuits 180 are short (microns) and numerous (thousands). As a result, the ISP-connection 160 in the preferred 3D-M_{SS} 200 has a large bandwidth.

Referring now to FIGS. 5A-5C, the substrate layout views of three preferred SUPs 100ij are shown. The embodiment of FIG. 5A corresponds to the SPU 100iji of FIG. 2A. The pattern-processing circuit 180 works with one 3D-M array 170. It is fully covered by the 3D-M array 170. The 3D-M array 170 has four peripheral circuits, including x-decoders 15, 15′ and y-decoders 17, 17′. The pattern-processing circuit 180 is bound by these four peripheral circuits. Because the 3D-M array 170 is stacked above the substrate 0, but not formed on the substrate 0, its projection on the substrate 0, not the 3D-P array itself, is shown in the area enclosed by dash line.

The embodiment of FIG. 5B corresponds to the SPU 100ij of FIG. 2B. The pattern-processing circuit 180 works with four 3D-M arrays 170A-170D. Each 3D-M array (e.g. 170) has two peripheral circuits (e.g. x-decoder 15A and y-decoder 17A). Below these four 3D-M arrays 170A-170D, the pattern-processing circuit 180 is formed. Apparently, the pattern-processing circuit 180 of FIG. 5B could be four times as large as that of FIG. 5A. It can perform more complex pattern-processing functions.

The embodiment of FIG. 5C corresponds to the SPU 100ij of FIG. 2C. The pattern-processing circuit 180 works with eight 3D-M arrays 170A-170D, 170W-170Z. These 3D-M arrays are divided into two sets: a first set 150A includes four 3D-M arrays 170A-170D, and a second set 150B includes four 3D-M arrays 170W-170Z. Below the four 3D-M arrays 170A-170D of the first set 150A, a first component 180A of the pattern-processing circuit 180 is formed. Similarly, below the four 3D-M array 170W-170Z of the second set 150B, a second component 1808 of the pattern-processing circuit 180 is formed. In this preferred embodiment, adjacent peripheral circuits (e.g. adjacent x-decoders 15A, 15C, or, adjacent y-decoders 17A, 17B) are separated by physical gaps (e.g. G). These physical gaps allow the formation of the routing channel 190Xa, 190Ya, 190Yb, which provide coupling between different components 180A, 180B, or between different pattern-processing circuits. Apparently, the pattern-processing circuit 180 of FIG. 5C could be eight times as large as that of FIG. 5A. It can perform even more complex pattern-processing functions.

In some embodiments of the present invention, the pattern-processing circuit 180 may perform partial pattern processing. For example, the pattern-processing circuit 180 only performs a preliminary pattern processing (e.g. a simple feature extraction and analysis). After being filtered by the preliminary pattern processing, the remaining patterns are sent to an external processor (e.g. CPU, GPU) to complete the full pattern processing. Because a majority of the patterns will be filtered out by the preliminary pattern processing, the patterns outputted from the pattern-processing circuit 180 are far fewer than the patterns in the preferred storage. This can alleviate the bandwidth requirement on the output bus 120.

One of the great benefits of the 3D-M_{SS} is that the additional string-searching capabilities add little or no cost. With the 3-D integration, adding pattern-processing circuits 180 into a 3D-M die will not increase the die size because the pattern-processing circuits 180 are formed under the 3D-M array 170. It should be noted that most of the substrate area 0 can be used to form the pattern-processing circuits 180, since the peripheral circuits (15, 17 . . . ) of the 3D-M array 170 only occupy a small portion of the substrate area 0. Better yet, because the peripheral circuits (15, 17 . . . ) of the 3D-M array 170 need to be formed anyway and the pattern-processing circuits 180 can be considered as a byproduct of the peripheral circuits (15, 17 . . . ) as they are formed at the same time, integrating the pattern-processing circuits 180 into the 3D-M die does not increase its overall manufacturing cost. For a given storage capacity, a “smart” 3D-M_{SS}, which has string-searching capabilities, costs almost as much as a conventional “dumb” 3D-M, which is just a simple storage.

Like a flash memory, the preferred 3D-M_{SS} of the present invention can be used to form a storage card (e.g. an SD card, a TF card) with in-situ string-searching capabilities, or a solid-state drive (SSD) with in-situ string-searching capabilities. To be more specific, a plurality of the preferred 3D-M_{SS} dice 200 can be vertically stacked, and/or horizontally placed inside a package to form a storage card; and, a plurality of storage cards can be placed together and electrically coupled to form an SSD. These preferred storage card and SSD can not only store computer data, but also perform string searching on the stored computer data in situ.

An amazing benefit of the preferred storage card and SSD with in-situ string-searching capabilities is that their string-searching time does not increase with the storage capacity. Because each SPU 100ij in each 3D-M_{SS} die 200 has its own pattern-processing circuit 180, this pattern-processing circuit 180 only needs to process the computer data stored in the 3D-M array 170 of this SPU 100ij. As a result, no matter how large is the capacity of the card/SSD, the string-searching time for the whole card/SSD is similar to that of a single SPU 100ij. This is much faster than a conventional computer system whose string-searching time increases linearly with the storage capacity.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A three-dimensional memory with in-situ string-searching capabilities (3D-Mss), comprising:
an input for transferring at least a search string;
a semiconductor substrate having transistors thereon;
a plurality of storage-processing units (SPU) on said semiconductor substrate, each of said SPUs comprising at least a three-dimensional memory (3D-M) array for storing at least a computer data and a pattern-processing circuit for searching said computer data for said search string;
wherein said pattern-processing circuit is formed on said semiconductor substrate; said 3D-M array is stacked above said pattern-processing circuit and communicatively coupled with said pattern-processing circuit by a plurality of contact vias.

2. The memory according to claim 1, further comprising first and second SPUs formed side-by-side.

3. The memory according to claim 2, wherein both of said first and second SPUs are communicatively coupled with said input.

4. The memory according to claim 2, further comprising an output for transferring at least a result of string searching.

5. The memory according to claim 4, wherein both of said first and second SPUs are communicatively coupled with said output.

6. The memory according to claim 1, wherein said 3D-M array is three-dimensional writable memory (3D-W) array.

7. The memory according to claim 6, wherein said 3D-W array is a three-dimensional one-time-programmable memory (3D-OTP) array.

8. The memory according to claim 6, wherein said 3D-W array is a three-dimensional multiple-time-programmable memory (3D-MTP) array.

9. The memory according to claim 1, wherein said pattern-processing circuit comprises at least a text-matching circuit.

10. The memory according to claim 1, wherein said pattern-processing circuit comprises at least a code-matching circuit.

11. The memory according to claim 1, wherein said pattern-processing circuit comprises at least a finite-state automata (FSA) circuit.

12. The processor according to claim 1, wherein said pattern-processing circuit further performs at least a sorting function.

13. The processor according to claim 1, wherein said pattern-processing circuit further performs at least a filtering function.

14. The processor according to claim 1, wherein said pattern-processing circuit further performs at least a malware-screening function.

15. The memory according to claim 1, wherein said 3D-M array at least partially covers said pattern-processing circuit.

16. The memory according to claim 1, wherein said pattern-processing circuit is covered by at least two 3D-M arrays.

17. The memory according to claim 1, wherein a preliminary pattern processing is performed at said memory.

18. The memory according to claim 17, wherein a full pattern processing is performed at an external processor.

19. The memory according to claim 1, wherein said memory is a portion of a storage card.

20. The memory according to claim 1, wherein said memory is a portion of a solid-state drive.
